(19) United States
(12) Patent Application Publication
(10) Pub. No.: US 2012/0331235 A1
(43) Pub. Date: Dec. 27, 2012

(54) MEMORY MANAGEMENT APPARATUS, MEMORY MANAGEMENT METHOD, CONTROL PROGRAM, AND RECORDING MEDIUM

(76) Inventors: Tomohiro KATORI, Tokyo (JP); Kazumi Sato, Kanagawa (JP)

(21) Appl. No.: 13/524,770

(22) Filed: Jun. 15, 2012

(30) Foreign Application Priority Data
Jun. 22, 2011 (JP) 2011-138699

(51) Int. Cl. G06F 12/08

(52) U.S. Cl. 711/137; 711/E12.057

(57) ABSTRACT

There is provided a memory management apparatus including a data input/output part for requesting to read data in units of blocks in a first size from a first storage medium and storing the data read from the first storage medium into a second storage medium, a data creating part for creating prefetch data obtained by converting a history of the request to read the data from the first storage medium into data of which read position and size are indicated in units of blocks in a second size, the request being issued by the data input/output part in response to a request from a program to be prefetched, and a prefetching part for requesting the data input/output part to prefetch the data of the program from the first storage medium to the second storage medium based on the prefetch data.

### BACKGROUND

The present disclosure relates to a memory management apparatus, a memory management method, a control program, and a recording medium, and particularly relates to a memory management apparatus, a memory management method, a control program, and a recording medium, which are preferably used when prefetch is performed.

There has been provided, in the past, a system in which a history of the access by a program to a nonvolatile storage device such as a hard disk is used for prefetching the data in the nonvolatile storage device next time the program is executed (for example, refer to Japanese Patent Application Laid-Open No. 2006-260067).

In the system, the data read request to a nonvolatile storage device is recorded while the program is executed. A method for prefetching is then determined based on the recorded history. At the subsequent executions of the program, the data are prefetched from the nonvolatile storage device based on the determined method for prefetching.

### SUMMARY

The optimization of the block size when the data are prefetched, however, is not particularly considered in the system disclosed in Japanese Patent Application Laid-Open No. 2006-260067 so that the data may not be efficiently prefetched.

It is desirable to prefetch data in an appropriate block size.

According to an embodiment of the present disclosure, there is provided a memory management apparatus which includes a data input/output part for requesting to read data in units of blocks in a first size from a first storage medium and storing the data read from the first storage medium into a second storage medium, a data creating part for creating prefetch data obtained by converting a history of the request to read the data from the first storage medium into data of which read position and size are indicated in units of blocks in a second size, the request being issued by the data input/output part in response to a request from a program to be prefetched, and a prefetching part for requesting the data input/output part to prefetch the data of the program from the first storage medium to the second storage medium based on the prefetch data.

According to the embodiments of the present disclosure described above, the second size can be configured to be based on a minimum unit capable of reading the data from the first storage medium.

According to the embodiments of the present disclosure described above, the data input/output part can be configured to request an access part to read the data from the first storage medium, the access part accessing the data of the first storage medium in units of blocks in the second size.

According to the embodiments of the present disclosure described above, the memory management apparatus can further include a setting part for setting the second size based on a format of the first storage medium.

According to the embodiments of the present disclosure described above, the memory management apparatus can further include a monitoring part for monitoring a usage of the second storage medium, wherein the data creating part can be configured to delete the read request issued by the data input/output part in response to the request from the program during a period of time during which the usage of the second storage medium has exceeded a predetermined threshold, and can create the prefetch data.

According to the embodiments of the present disclosure described above, the memory management apparatus can further include a monitoring part for monitoring the usage of the second storage medium, wherein the prefetching part can be configured to perform prefetch or stop the prefetch based on the usage of the second storage medium.

According to the embodiments of the present disclosure described above, the memory management apparatus can further include a prefetching control part for instructing the data creating part to create the prefetch data when there is not the prefetch data for the program, and instructing the prefetching part to prefetch the data of the program when there is the prefetch data for the program, in order to execute the program.

According to the embodiments of the present disclosure described above, the memory management apparatus can further include a forecasting part for forecasting a program to be next executed, wherein the prefetching control part can be configured to instruct the data creating part to create the prefetch data when there is not the prefetch data for the forecasted program, and instruct the prefetching part to prefetch the data of the forecasted program when there is the prefetch data for the forecasted program.

According to another embodiment of the present disclosure, there is provided a memory management method implemented by a memory management apparatus including a data input/output part for requesting to read data in units of blocks in a first size from a first storage medium and storing the data read from the first storage medium into a second storage medium, and the method includes: creating prefetch data obtained by converting a history of the request to read the data from the first storage medium into data of which read position and size are indicated in units of blocks in a second size, the request being issued by the data input/output part in response to a request from a program to be prefetched; and requesting the data input/output part to prefetch the data of the program from the first storage medium to the second storage medium based on the prefetch data.

According to another embodiment of the present disclosure, there is provided a control program which causes a computer to perform a process including: creating prefetch data obtained by converting a history of a request to read data from a first storage medium into data of which read position and size are indicated in units of blocks in a second size, the request being issued by a data input/output part in response to a request from a program to be prefetched, the data input/output part requesting to read data in units of blocks in a first size from the first storage medium and stores the data read from the first storage medium into a second storage medium; and requesting the data input/output part to prefetch the data of the program from the first storage medium to the second storage medium based on the prefetch data.

According to another embodiment of the present disclosure, prefetch data are created. The prefetch data are obtained by converting a history of the request to read the data from the first storage medium into data of which read position and size are indicated in units of blocks in a second size. The request is issued by a data input/output part in response to a request from a program to be prefetched. The data input/output part requests to read data in units of blocks in a first size from the first storage medium and stores the data read from the first storage medium into the second storage medium. The data input/output part is requested to prefetch the data of the program from the first storage medium to the second storage medium based on the prefetch data.

According to another embodiment of the present disclosure, the data can be prefetched in an appropriate block size.

### BRIEF DESCRIPTION OF THE DRAWINGS

FIG. 1 is a block diagram of an information processing system according to an embodiment of the present disclosure;

FIG. 2 is a flowchart describing prefetch performed by the information processing system shown in FIG. 1;

FIG. 3 is a block diagram of an exemplary functional configuration when the present disclosure is applied to a Blu-ray disc recorder;

FIG. 4 is a block diagram of an exemplary functional configuration when the present disclosure is applied to a tablet terminal;

FIG. 5 is a block diagram of a first exemplary modification of the information processing system using the present disclosure;

FIG. 6 is a flowchart describing prefetch performed by the information processing system shown in FIG. 5;

FIG. 7 is a block diagram of a second exemplary modification of the information processing system using the present disclosure;

FIG. 8 is a flowchart describing prefetch performed by the information processing system shown in FIG. 7; and

FIG. 9 is a block diagram of an exemplary configuration of a computer.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments of the present disclosure will be described hereinafter. Note that the description will be given in the following order: 1. Basic Configuration of Embodiment of the Present Disclosure; 2. First Concrete Example of Embodiment (example of the application to a Blu-ray disc recorder); 3. Second Concrete Example of Embodiment (example of the application to a tablet terminal); 4. First Exemplary Modification (example of prefetch after forecasting the activation of a program); 5. Second Exemplary Modification (example of prefetch while monitoring memory usage); and 6. Other Exemplary Modifications.

### 1. Basic Configuration of Embodiment

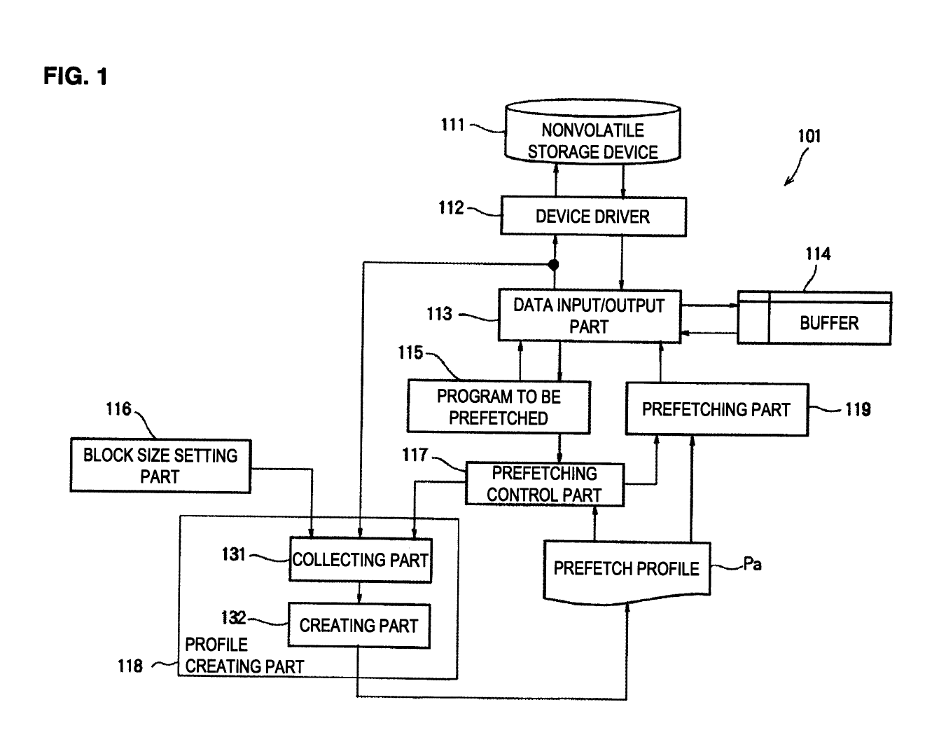

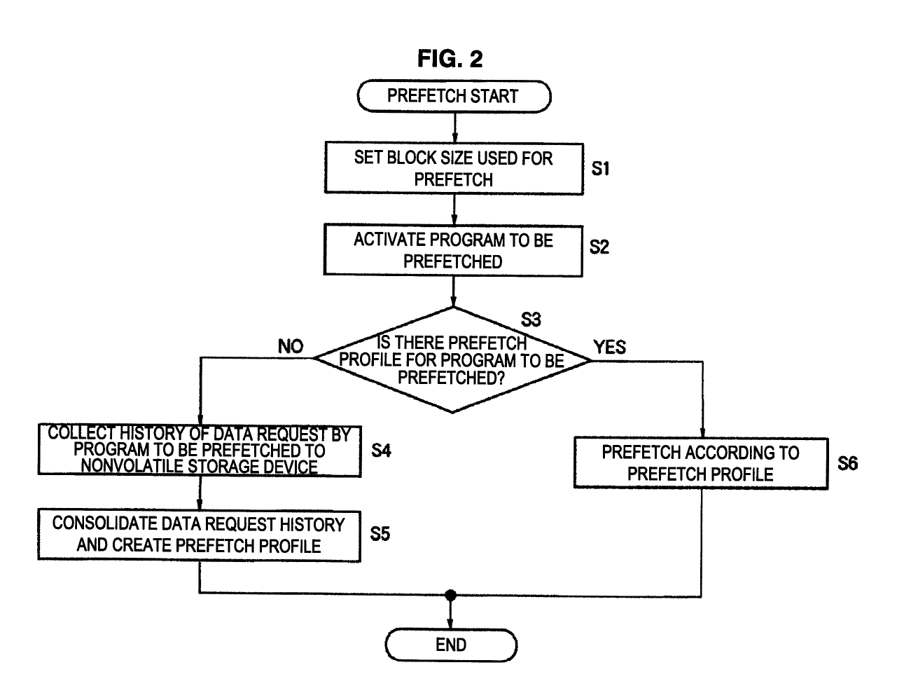

First, a basic configuration of an embodiment of the present disclosure will be described with reference to FIGS. 1 and 2.

### [Exemplary Configuration of Information Processing System 101]

FIG. 1 is a block diagram of an exemplary functional configuration of an information processing system 101 according to an embodiment of the present disclosure.

The information processing system 101 includes a nonvolatile storage device 111, a device driver 112, a data input/output part 113, a buffer 114, a program to be prefetched 115, a block size setting part 116, a prefetching control part 117, a profile creating part 118, and a prefetching part 119. The profile creating part 118 includes a collecting part 131, and a creating part 132.

Note that the data input/output part 113, the block size setting part 116, the prefetching control part 117, the profile creating part 118, and the prefetching part 119 are implemented by, for example, an operating system executed by the information processing system 101.

Also, in the information processing system 101, prefetch is performed before the program to be prefetched 115 is executed. At least a part of data necessary to execute the program to be prefetched 115 is read from the nonvolatile storage device 111 and is stored in the buffer 114 in the prefetch as described below. In this case, the data to be prefetched includes not only data used for processing the program to be prefetched but also the program to be prefetched 115 itself.

The nonvolatile storage device 111 stores permanent data such as an executable program or file.

The device driver 112 accesses the nonvolatile storage device 111 in units of storage blocks according to a request from the data input/output part 113. The storage block is a block in a predetermined size (e.g., 128 kilobytes). In other words, the device driver 112 reads data from the nonvolatile storage device 111 and writes data to the nonvolatile storage device 111 in units of the storage blocks. The device driver 112 then transmits the data that has been read from the nonvolatile storage device 111 to the data input/output part 113.

Note that the size of the storage block is set to, for example, a minimum unit of the size accessible to data in the nonvolatile storage device 111.

The data input/output part 113 performs memory management by a demand paging method. Accordingly, the data input/output part 113 requests the device driver 112 to access the nonvolatile storage device 111 in units of pages according to a request from the program to be prefetched 115 or the like. The page is a block in a predetermined size (e.g., four kilobytes). In other words, the data input/output part 113 requests the device driver 112 to read data from the nonvolatile storage device 111 and write data to the nonvolatile storage device 111 in units of pages. The data input/output part 113 transmits the data that has been read from the nonvolatile storage device 111 by the device driver 112 to the requestor.

To speed up the process, the data input/output part 113 also makes the buffer 114 store the data that has been read from the nonvolatile storage device 111 in order to read the data stored in the buffer 114 and transmit the data to the requestor next time the reading of the same data is requested.

The data input/output part 113 also prefetches data according to a request from the prefetching part 119. In other words, the data input/output part 113 requests the device driver 112 to read data from the nonvolatile storage device 111 according to a request from the prefetching part 119 and then makes the buffer 114 store the data that has been read from the nonvolatile storage device 111 by the device driver 112.

The buffer 114 is a region for temporarily storing the data that has been accessed or prefetched among those stored in the nonvolatile storage device 111. The buffer 114 is provided on a storage device that can be accessed faster than the nonvolatile storage device 111. The buffer 114 corresponds to, for example, a page cache on a main memory managed by an operating system.

The program to be prefetched 115 is for implementing a main function of the information processing system 101.

The block size setting part 116 sets the block size that becomes a unit when the data input/output part 113 requests the device driver 112 to read data while the data are prefetched from the nonvolatile storage device 111 (hereinafter, referred to as a prefetch block size). The block size setting part 116 then notifies the collecting part 131 of the set prefetch block size.

The prefetching control part 117 determines whether prefetch will be performed or a prefetch profile Pa will be created when the program to be prefetched 115 is executed. The prefetching control part 117 instructs the prefetching part 119 to perform the prefetch when determining that the prefetch is performed. On the other hand, the prefetching control part 117 instructs the collecting part 131 to create the prefetch profile Pa when determining that the prefetch profile Pa is created.

The profile creating part 118 creates the prefetch profile Pa that is data for indicating a prefetching process to the prefetching part 119 and that includes the position, size, and prefetching order of the data to be prefetched on the nonvolatile storage device 111.

Specifically, the collecting part 131 in the profile creating part 118, as described below, collects the history of the data requests of the program to be prefetched 115 to the nonvolatile storage device 111 and supplies the creating part 132 with the history.

The creating part 132 creates the prefetch profile Pa based on the history collected by the collecting part 131, as described below.

The prefetching part 119 prefetches the data according to the instruction from the prefetching control part 117. In other words, the prefetching part 119 requests the data necessary to execute the program to be prefetched 115 from the data input/output part 113 based on the prefetch profile Pa before the program to be prefetched 115 is executed. As a result, the requested data is copied from the nonvolatile storage device 111 to the buffer 114. Accordingly, the data are read from the buffer 114 when the program to be prefetched 115 requests the data from the data input/output part 113. This can cause the program to be prefetched 115 to obtain the data at high speed.

### [Prefetch by Information Processing System 101]

Next, prefetch that is performed by the information processing system 101 will be described with reference to the flowchart shown in FIG. 2.

The block size setting part 116 sets the block size for prefetching (prefetch block size) in step S1 and then notifies the set prefetch block size to the collecting part 131.

The program to be prefetched 115 is activated in step S2. This causes the prefetching control part 117 to detect the activation of the program to be prefetched 115 and to be activated.

In step S3, the prefetching control part 117 determines whether there is the prefetch profile Pa for the program to be prefetched 115. The process goes to step S4 when it is determined that there is not the prefetch profile Pa for the program to be prefetched 115.

The collecting part 131 collects the history of the data request of the program to be prefetched 115 to the nonvolatile storage device 111 in step S4. Specifically, the collecting part 131 monitors the data read request from the nonvolatile storage device 111. The request is issued by the data input/output part 113 to the device driver 112 according to the request from the program to be prefetched 115. The collecting part 131 then collects, based on the prefetch block size, the history of the data read request (hereinafter, referred to as a data request history). The request is issued by the data input/output part 113 according to the request from the program to be prefetched 115.

Specifically, the collecting part 131 converts the data read request from the data input/output part 113 page by page into that based on the prefetch block size. In other words, the collecting part 131 converts the read position and size of the data indicated in units of pages in response to the data read request into those in units of blocks in the prefetch block size. The collecting part 131 then records the converted data read request.

Note that, time information can be also recorded at that time. The information includes, for example, the time when the data read request has been issued and the time interval between the issued read request and the previous one.

Accordingly, the data request history is obtained by converting the history of the data read request into data of which read position and size are indicated in units of blocks in the prefetch block size. The data read request is issued by the data input/output part 113 in response to the request from the program to be prefetched 115. In other words, the read position is indicated as the position addressed in units of blocks in the prefetch block size. The size is indicated in the number of blocks in the prefetch block size.

The creating part 132 consolidates the data request history and creates the prefetch profile Pa in step S5. Specifically, the creating part 132 obtains the data request history from the collecting part 131, and extracts the read position and size of the data that are indicated in the read request recorded in the data request history. The creating part 132 then creates the prefetch profile Pa where the extracted read position and size are listed in a predetermined order (for example, order to read). Note that, at that time, the creating part 132 combines the data having the regions to be read adjacent to each other and deletes the data having the region overlapped with another.

Note that the range where the prefetch profile Pa is created, namely, the range where the data is prefetched is determined based on, for example, the specification or the features of the information processing system 101, the capacity of the buffer 114, or the function implemented by the program to be prefetched 115. For example, the data necessary until the activation of the program to be prefetched 115 is completed, the data necessary for the process typically executed while the program to be prefetched 115 runs, or the data necessary to execute all the processes in the program to be prefetched 115 is set as the data to be prefetched and the prefetch profile Pa is created for the data.

After the prefetch profile Pa is created, the process is terminated.

On the other hand, the process goes to step S6 when it is determined in step S3 that there is the prefetch profile Pa for the program to be prefetched 115.

The prefetching part 119 performs prefetch according to the prefetch profile Pa in step S6. Specifically, the prefetching control part 117 instructs the prefetching part 119 to perform prefetch. The prefetching part 119 sequentially requests, from the data input/output part 113, the data having the position and size indicated by the prefetch profile Pa.

The data input/output part 113 requests the device driver 112 to read the requested data. The device driver 112 reads the data from the nonvolatile storage device 111 and supplies the data to the data input/output part 113 in response to the request from the data input/output part 113. The data input/output part 113 makes the buffer 114 store the obtained data.

After that, the prefetch is terminated.

Note that the prefetch block size is set based on, for example, a storage block that is a unit when the device driver 112 accesses the nonvolatile storage device 111. In other words, the prefetch block size is set as, for example, the same size as the storage block or the size as an integral multiple of the size of the storage block. Thus, the read position and size of the data in the prefetch profile Pa can be indicated in units of the storage blocks.

When the size of the storage block is larger than that of the page that is a unit when the data input/output part 113 accesses the nonvolatile storage device 111, the total number of the blocks in units of the storage blocks in the nonvolatile storage device 111 is smaller than the total number of the blocks in units of the pages. Accordingly, the information amount (address size) of the data indicating the read position in the prefetch profile Pa is smaller than that in a prefetch profile created in units of the pages. This can decrease the size of the data in the prefetch profile Pa. This is particularly efficient when applied to, for example, an embedded device having a small system resource.

When prefetch is performed, the data input/output part 113 also requests, based on the size of the storage block, the device driver 112 to read the data. Accordingly, the device driver 112 can read the data from the nonvolatile storage device 111 and transmit the data to the data input/output part 113 in the same size as when the data are requested by the data input/output part 113. This can cause an efficient data input/output between the nonvolatile storage device 111 and the data input/output part 113, and can reduce the load of the process or speed up the process.

### 2. First Embodiment

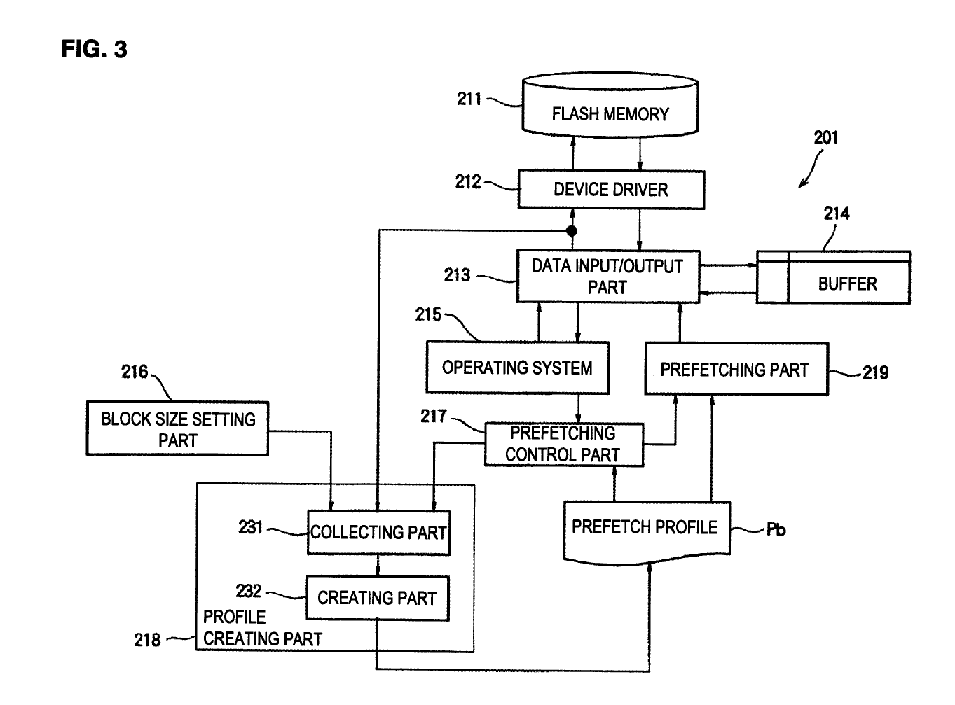

FIG. 3 is a block diagram of an exemplary functional configuration when the information processing system 101 is applied to a Blu-ray disc recorder.

Note that FIG. 3 shows only the components related to the present disclosure in a Blu-ray disc recorder 201 and omits the other components. Also, in FIG. 3, the parts corresponding to those shown in FIG. 1 are denoted with reference numerals having the same last two digits as those shown in FIG. 1, and the repeated description of the same process is properly omitted.

In the Blu-ray disc recorder 201, a flash memory 211 is adopted as a specific example of the nonvolatile storage device 111 of the information processing system 101 shown in FIG. 1. An operating system 215 is adopted as a specific example of the program to be prefetched 115.

When activated, the Blu-ray disc recorder 201 reads the operating system 215 from the flash memory 211, and the operating system 215 performs various processes to be performed when the Blu-ray disc recorder 201 is activated. Also, the Blu-ray disc recorder 201 prefetches a part to be prefetched of the operating system 215 and the data necessary to process the part to be prefetched.

Note that the part to be prefetched of the operating system 215 is set at, for example, a part that is executed before the activation of the Blu-ray disc recorder 201 is completed, or a part that is surely executed during the activation of the Blu-ray disc recorder 201.

A block size setting part 216 sets, for example, the block size of the flash memory 211 as the prefetch block size, and notifies a collecting part 231 of the prefetch block size. The block size of the flash memory 211 is a constant value predetermined by the system designer or the like.

When the Blu-ray disc recorder 201 is activated for the first time, the collecting part 231 collects the history of the data read request issued by the data input/output part 213 (data request history) in response to the request from the operating system 215, based on the block size of the flash memory 211. A creating part 232 creates a prefetch profile Pb for the operating system 215 based on the collected data request history.

At the subsequent activations of the Blu-ray disc recorder 201, a prefetching part 219 prefetches the data from the flash memory 211 based on the prefetch profile Pb. Thus, the data input/output part 213 requests a device driver 212 to read the data in units of blocks in the block size of the flash memory 211. Accordingly, the device driver 212 reads the data from the flash memory 211 and transmits the data to the data input/output part 213 in the same size as when the data are requested by the data input/output part 213.

### 3. Second Embodiment

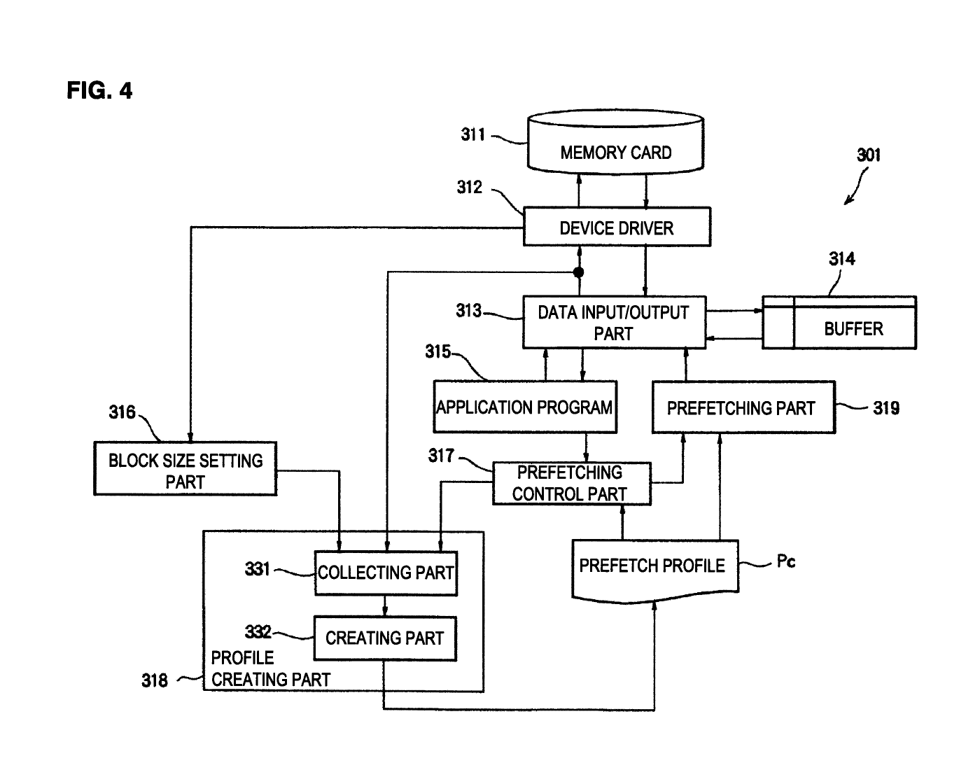

FIG. 4 is a block diagram of an exemplary functional configuration when the information processing system 101 is applied to a tablet terminal.

Note that FIG. 4 shows only the components related to the present disclosure in a tablet terminal 301 and omits the other components. Also, in FIG. 4, the parts corresponding to those shown in FIG. 1 are denoted with reference numerals having the same last two digits as those shown in FIG. 1, and the repeated description of the same process is properly omitted.

In the tablet terminal 301, an external memory card 311 is adopted as a specific example of the nonvolatile storage device 111 of the information processing system 101 shown in FIG. 1. An application program 315 is adopted as a specific example of the program to be prefetched 115.

The tablet terminal 301 implements a predetermined function by executing the application program 315 stored in the memory card 311. The tablet terminal 301 also prefetches a part to be prefetched in the application program 315 and the data necessary to process the part to be prefetched.

Note that the part to be prefetched in the application program 315 is set at a part that is surely executed when the application program 315 is executed, regardless of, for example, the user's operation or the contents of the process.

When the memory card 311 is mounted on the tablet terminal 301, the block size setting part 316 analyzes the format of the memory card 311 based on the information supplied from a device driver 312. The block size setting part 316 finds the optimal block size to access the memory card 311 based on the analysis result. The block size setting part 316 then sets the found block size as the prefetch block size and notifies the collecting part 331 of the prefetch block size.

When the application program 315 is activated for the first time, the collecting part 331 collects the history of the data read request issued by the data input/output part 313 (data request history) in response to the request from the application program 315, based on the optimal block size of the memory card 311. A creating part 332 creates a prefetch profile Pc for the application program 315 based on the collected data request history.

At the subsequent activations of the application program 315, a prefetching part 319 prefetches the data from the memory card 311 based on the prefetch profile Pc. Thus, the data input/output part 313 requests the device driver 312 to read the data in units of blocks in the optimal block size of the memory card 311. Accordingly, the device driver 312 reads the data from the memory card 311 and transmits the data to the data input/output part 313 in the same size as when the data are requested by the data input/output part 313.

### 4. First Exemplary Modification

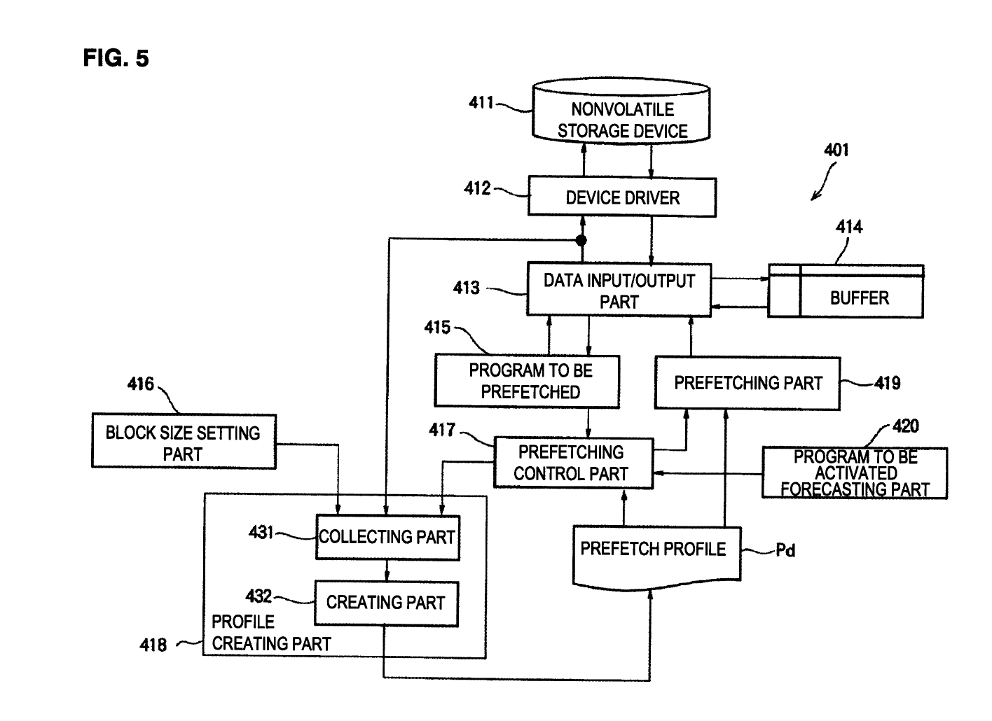

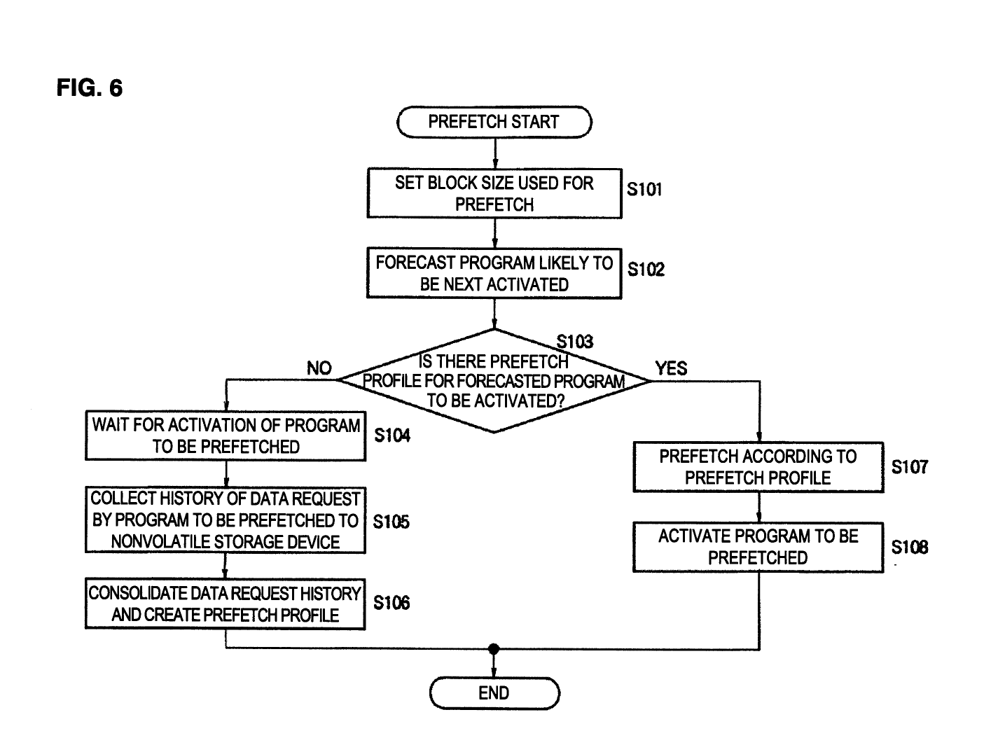

Next, the first exemplary modification of the information processing system 101 shown in FIG. 1 will be described with reference to FIGS. 5 and 6.

### [Exemplary Configuration of Information Processing System 401]

FIG. 5 is a block diagram of an exemplary configuration of an information processing system 401 which is the first exemplary modification of the information processing system 101.

Note that, in FIG. 5, the parts corresponding to those shown in FIG. 1 are denoted with reference numerals having the same last two digits as those shown in FIG. 1, and the repeated description of the same process is properly omitted.

The information processing system 401 differs from the information processing system 101 in that the information processing system 401 additionally includes a program to be activated forecasting part 420.

The program to be activated forecasting part 420 forecasts a program likely to be next activated among the programs executed in the information processing system 101 and notifies a prefetching control part 417 of the forecasted result.

The prefetching control part 417 sets the program that has been forecasted to be likely to be next activated as a program to be prefetched 415. The prefetching control part 417 then determines whether the program to be prefetched 415 will be prefetched or a prefetch profile Pd for the program to be prefetched 415 will be created. The prefetching control part 417 then instructs a prefetching part 419 to prefetch when determining that the prefetch is performed. On the other hand, the prefetching control part 417 instructs a collecting part 431 to create the prefetch profile Pd when determining that the prefetch profile Pd is created.

### [Prefetch by Information Processing System 401]

Next, the prefetch performed by the information processing system 401 will be described with reference to the flowchart shown in FIG. 6.

A block size used for the prefetch is set in step S101 in the same manner as the process in step S1 shown in FIG. 2.

The program to be activated forecasting part 420 forecasts a program likely to be next activated in step S102 and notifies the prefetching control part 417 of the forecasted result. This activates the prefetching control part 417.

In step S103, the prefetching control part 417 determines whether there is the prefetch profile Pd for the program forecasted to be activated. The process goes to step S104 when it is determined that there is not the prefetch profile Pd for the program forecasted to be activated (namely, the program to be prefetched 415).

In step S104, the prefetching control part 417 waits for the activation of the program to be prefetched 415. The process goes to step S105 when the prefetching control part 417 detects the activation of the program to be prefetched 415.

In step S105, the data request history of the program to be prefetched 415 to a nonvolatile storage device 411 is collected in the same manner as the process in step S4 shown in FIG. 2.

In step S106, the data request history is consolidated in the same manner as the process in step S5 shown in FIG. 2 to create the prefetch profile Pd for the program to be prefetched 415.

The process is terminated after the prefetch profile Pd is created.

On the other hand, the process goes to step S107 when it is determined that there is the prefetch profile Pd for the program forecasted to be activated (program to be prefetched 415) in step S103.

In step S107, the prefetch is performed according to the prefetch profile Pd in the same manner as the process in step S6 shown in FIG. 2.

In step S108, the program to be prefetched 415 is activated. The data related to the execution of the program to be prefetched 415 can be obtained at high speed because the program to be prefetched 415 has been already prefetched at that time.

After that, the prefetch is terminated.

### 5. Second Exemplary Modification

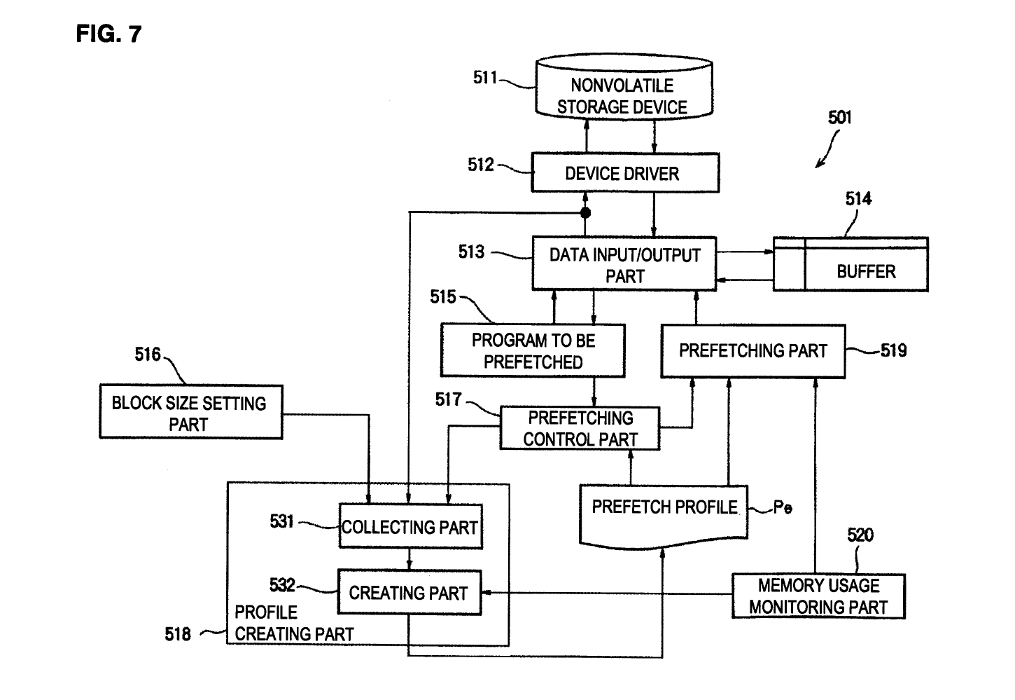

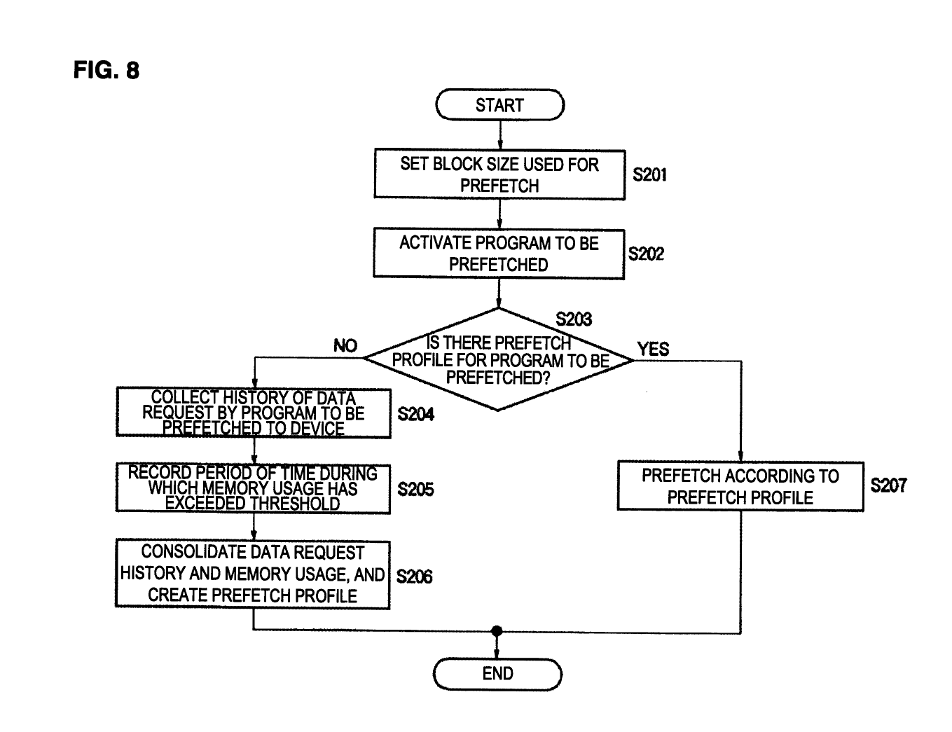

Next, the second exemplary modification of the information processing system 101 shown in FIG. 1 will be described with reference to FIGS. 7 and 8.

### [Exemplary Configuration of Information Processing System 501]

FIG. 7 is a block diagram of an exemplary configuration of an information processing system 501 which is the second exemplary modification of the information processing system 101.

Note that, in FIG. 7, the parts corresponding to those shown in FIG. 1 are denoted with reference numerals having the same last two digits as those shown in FIG. 1, and the repeated description of the same process is properly omitted.

The information processing system 501 differs from the information processing system 101 in that the information processing system 501 additionally includes a memory usage monitoring part 520.

The memory usage monitoring part 520 monitors the usage of a storage device including a buffer 514 (hereinafter, referred to as a memory usage) and notifies a prefetching part 519 or a creating part 532 of the result.

As described below, the creating part 532 creates a prefetch profile Pe for a program to be prefetched 515 based on the data request history collected by a collecting part 531 and the monitored result of the memory usage by the memory usage monitoring part 520.

As necessary, the prefetching part 519 prefetches or stops prefetching the data based on the memory usage notified from the memory usage monitoring part 520.

### [Prefetch by Information Processing System 501]

Next, the prefetch performed by the information processing system 501 will be described with reference to the flowchart shown in FIG. 8.

A block size used for the prefetch is set in step S201 in the same manner as the process in step S1 shown in FIG. 2.

The program to be prefetched 515 is activated in step S202 in the same manner as the process in step S2 shown in FIG. 2.

It is determined whether there is the prefetch profile Pe for the program to be prefetched 515 in step S203 in the same manner as the process in step S3 shown in FIG. 2. When it is determined that there is not the prefetch profile Pe, the process goes to step S204.

The data request history of the program to be prefetched 515 to a nonvolatile storage device 511 is collected in step S204 in the same manner as the process in step S4 shown in FIG. 2.

In step S205, the memory usage monitoring part 520 records the period of time during which the memory usage has exceeded a threshold.

In step S206, the creating part 532 consolidates the data request history and the memory usage and then creates the prefetch profile Pe. Specifically, the creating part 532 obtains the data request history from the collecting part 531 and also obtains, from the memory usage monitoring part 520, the information indicating the period of time during which the memory usage has exceeded the threshold. When there is a period of time during which the memory usage has exceeded the threshold, the creating part 532 deletes the history during the period of time from the obtained data request history and divides the data request history before and after the deleted part.

The creating part 532 then creates the prefetch profile Pe for the program to be prefetched 515 based on the data request history in the same manner as the process in step S5 shown in FIG. 2. Thus, when there is a period of time during which the memory usage has exceeded the threshold, the prefetch profile Pe is created except for the data read request issued by a data input/output part 513 during the period of time. In this case, a plurality of prefetch profiles Pe is sometimes created.

After the prefetch profile Pe is created, the process is terminated.

On the other hand, when it is determined in step S203 that there is the prefetch profile Pe for the program to be prefetched 115, the process goes to step S207.

Prefetch is performed according to the prefetch profile Pe in step S207 in the same manner as the process in step S6 shown in FIG. 2.

At that time, the prefetch is stopped before the memory usage exceeds the threshold because the prefetch profile Pe during the period of time during which the memory usage has exceeded the threshold is not created. When there is the prefetch profile Pe after the memory usage has been equal to or less than the threshold again, the prefetch is resumed, for example, based on the time information including the time of the data read request and the time interval between the requests in the case where the prefetch profile Pe includes the time information. Alternatively, the prefetch can be resumed when the memory usage notified by the memory usage monitoring part 520 becomes equal to or less than a predetermined value that is less than the threshold.

This prevents the prefetch from collecting a memory region in a storage device including the buffer 514 while the memory usage exceeds the threshold. Accordingly, this prevents, for example, writing the data that has been subsequently prefetched on the data to which the program to be prefetched 515 has not referred yet.

On the other hand, the data are prefetched into the buffer 514 during the period of time during which the memory usage is equal to or less than the threshold so that the data can be obtained at high speed.

After that, the prefetch is terminated.

### 6. Other Exemplary Modifications

Other exemplary modifications other than the above-described exemplary modification according to the embodiments of the present disclosure will be described below.

### Exemplary Modification 1

In the above-described example, a block size is changed to collect the data request history. The timing for changing the block size, however, is not limited to the example. For example, the block size can be changed when a prefetch profile is created while the data request history is collected in the unchanged block size.

### Exemplary Modification 2

Further, the present disclosure can be applied when another memory managing mechanism is included between the device driver and the data input/output part. In other words, the present disclosure can be applied when the data input/output part accesses the device driver through the memory managing mechanism.

### Exemplary Modification 3

Furthermore, in the above-described second exemplary modification, for example, the history during the period of time during which the memory usage has exceeded the threshold is not deleted from the data request history and a predetermined piece of information indicating the period of time can be added to the data request history. The prefetch profile Pe can be then created except for the history of the period of time. A prefetch profile of the whole period of time can be created and the predetermined information indicating the period of time can be added to the prefetch profile.

Alternatively, while the memory usage is not monitored when the prefetch profile Pe is created, the prefetch and the stop of the prefetch can be controlled based on the memory usage when the prefetch is performed. For example, when the memory usage notified by the memory usage monitoring part 520 becomes equal to or larger than the threshold, the prefetch can be stopped. When the memory usage becomes equal to or less than a predetermined value less than the threshold, the prefetch can be resumed.

### Exemplary Modification 4

Furthermore, in each of the embodiments and the exemplary modifications, when the prefetching part monitors the data in the buffer and the data having the position and size indicated in the prefetch profile has been already stored in the buffer, the data may not be requested from the data input/output part 113. This can reduce an unnecessary data read request.

### [Exemplary Configuration of Computer]

The above-described sequence of processes can be implemented by hardware and also by software. When software implements the processes, a program constituting the software is installed on the computer. In this case, the computer includes, for example, a computer embedded in dedicated hardware or a general personal computer capable of implementing each function by installing each program.

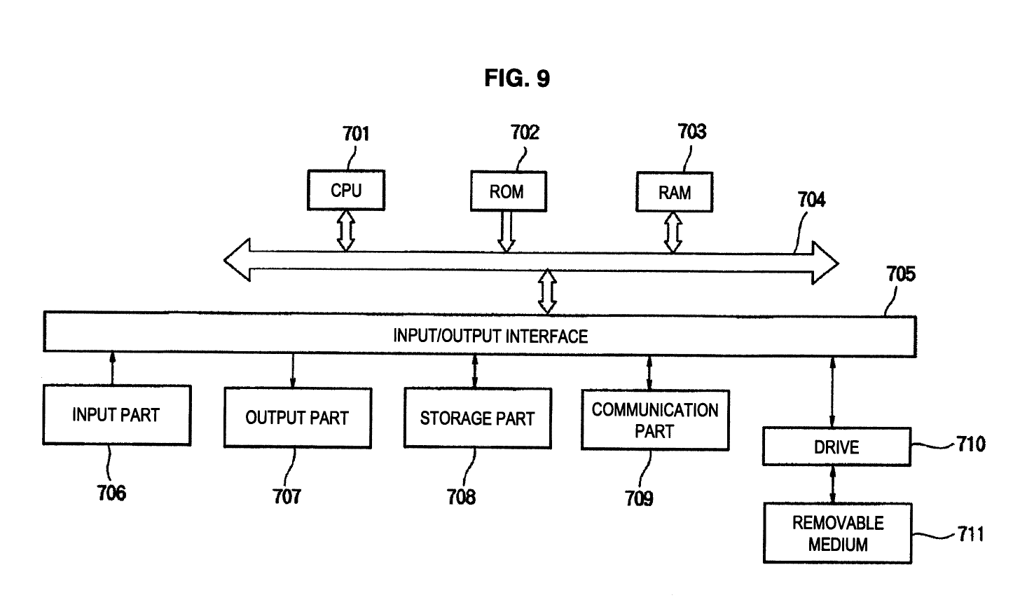

FIG. 9 is a block diagram of an exemplary configuration of hardware of a computer implementing the above-described sequence of processes by a program.

A central processing unit (CPU) 701, a read only memory (ROM) 702, and a random access memory (RAM) 703 are interconnected through a bus 704 in a computer.

The bus 704 is also connected to an input/output interface 705. The input/output interface 705 is connected to an input part 706, an output part 707, a storage part 708, a communication part 709, and a drive 710.

The input part 706 includes a keyboard, a mouse, a microphone, and the like. The output part 707 includes a display, a loud speaker, and the like. The storage part 708 includes a hard disk, a nonvolatile memory, and the like. The communication part 709 includes a network interface and the like. The drive 710 drives a removable medium 711 such as a magnetic disk, an optical disk, a magneto optical disk or a semiconductor memory.

In the computer including the above, for example, the CPU 701 loads a program stored in the storage part 708 into the RAM 703 through the input/output interface 705 and the bus 704, and executes the program so that the above-described sequence of processes is implemented.

The program executed by the computer (CPU 701) can be provided, for example, after recorded on the removable medium 711 as a package medium or the like. Alternatively, the program can be provided through a wired or wireless transmission medium such as a local area network, the Internet, and a digital satellite broadcast.

In the computer, the removable medium 711 is mounted on the drive 710 so that the program can be installed on the storage part 708 through the input/output interface 705. Alternatively, the program can be installed on the storage part 708 after received by the communication part 709 through a wired or wireless transmission medium. Otherwise, the program can be installed on the ROM 702 or the storage part 708 in advance.

Note that the program executed by the computer can be executed in time order along with the order described herein, or can be executed in parallel or at the necessary timing, for example, when called.

Further, note that the word “system” herein means a general apparatus including a plurality of devices or mechanisms.

It should be understood by those skilled in the art that various modifications, combinations, sub-combinations and alterations may occur depending on design requirements and other factors insofar as they are within the scope of the appended claims or the equivalents thereof.

The present technology may also be configured as below.

(1) A memory management apparatus comprising:

a data input/output part for requesting to read data in units of blocks in a first size from a first storage medium and storing the data read from the first storage medium into a second storage medium;

a data creating part for creating prefetch data obtained by converting a history of the request to read the data from the first storage medium into data of which read position and size are indicated in units of blocks in a second size, the request being issued by the data input/output part in response to a request from a program to be prefetched; and

a prefetching part for requesting the data input/output part to prefetch the data of the program from the first storage medium to the second storage medium based on the prefetch data.

(2) The memory management apparatus according to (1),

wherein the second size is configured to be based on a minimum unit capable of reading the data from the first storage medium.

(3) The memory management apparatus according to (2),

wherein the data input/output part is configured to request an access part to read the data from the first storage medium, the access part accessing the data of the first storage medium in units of blocks in the second size.

(4) The memory management apparatus according to (1), further comprising:

a setting part for setting the second size based on a format of the first storage medium.

(5) The memory management apparatus according to any one of (1) to (4), further comprising:

a monitoring part for monitoring a usage of the second storage medium,

wherein the data creating part is configured to delete the read request issued by the data input/output part in response to the request from the program during a period of time during which the usage of the second storage medium has exceeded a predetermined threshold, and creates the prefetch data

(6) The memory management apparatus according to any one of (1) to (4), further comprising:

a monitoring part for monitoring the usage of the second storage medium,

wherein the prefetching part is configured to perform prefetch or stops the prefetch based on the usage of the second storage medium.

(7) The memory management apparatus according to any one of (1) to (6), further comprising:

a prefetching control part for instructing the data creating part to create the prefetch data when there is not the prefetch data for the program, and instructing the prefetching part to prefetch the data of the program when there is the prefetch data for the program, in order to execute the program.

(8) The memory management apparatus according to (7), further comprising:

a forecasting part for forecasting a program to be next executed,

wherein the prefetching control part is configured to instruct the data creating part to create the prefetch data when there is not the prefetch data for the forecasted program, and instruct the prefetching part to prefetch the data of the forecasted program when there is the prefetch data for the forecasted program.

(9) A memory management method implemented by a memory management apparatus including a data input/output part for requesting to read data in units of blocks in a first size from a first storage medium and storing the data read from the first storage medium into a second storage medium, the method comprising:

creating prefetch data obtained by converting a history of the request to read the data from the first storage medium into data of which read position and size are indicated in units of blocks in a second size, the request being issued by the data input/output part in response to a request from a program to be prefetched; and

requesting the data input/output part to prefetch the data of the program from the first storage medium to the second storage medium based on the prefetch data.

(10) A control program for causing a computer to perform a process comprising:

creating prefetch data obtained by converting a history of a request to read data from a first storage medium into data of which read position and size are indicated in units of blocks in a second size, the request being issued by a data input/output part in response to a request from a program to be prefetched, the data input/output part requesting to read data in units of blocks in a first size from the first storage medium and storing the data read from the first storage medium into a second storage medium; and

requesting the data input/output part to prefetch the data of the program from the first storage medium to the second storage medium based on the prefetch data.

(11) A computer readable recording medium in which the program according to claim 10 has been recorded.

The present disclosure contains subject matter related to that disclosed in Japanese Priority Patent Application JP 2011-138699 filed in the Japan Patent Office on Jun. 22, 2011, the entire content of which is hereby incorporated by reference.

What is claimed is:

1. A memory management apparatus comprising:
a data input/output part for requesting to read data in units of blocks in a first size from a first storage medium and storing the data read from the first storage medium into a second storage medium;
a data creating part for creating prefetch data obtained by converting a history of the request to read the data from the first storage medium into data of which read position and size are indicated in units of blocks in a second size, the request being issued by the data input/output part in response to a request from a program to be prefetched; and
a prefetching part for requesting the data input/output part to prefetch the data of the program from the first storage medium to the second storage medium based on the prefetch data.

2. The memory management apparatus according to claim 1,
wherein the second size is configured to be based on a minimum unit capable of reading the data from the first storage medium.

3. The memory management apparatus according to claim 2,
wherein the data input/output part is configured to request an access part to read the data from the first storage medium, the access part accessing the data of the first storage medium in units of blocks in the second size.

4. The memory management apparatus according to claim 1, further comprising:
a setting part for setting the second size based on a format of the first storage medium.

5. The memory management apparatus according to claim 1, further comprising:
a monitoring part for monitoring a usage of the second storage medium,
wherein the data creating part is configured to delete the read request issued by the data input/output part in response to the request from the program during a period of time during which the usage of the second storage medium has exceeded a predetermined threshold, and creates the prefetch data.

6. The memory management apparatus according to claim 1, further comprising:
a monitoring part for monitoring the usage of the second storage medium,
wherein the prefetching part is configured to perform prefetch or stops the prefetch based on the usage of the second storage medium.

7. The memory management apparatus according to claim 1, further comprising:
a prefetching control part for instructing the data creating part to create the prefetch data when there is not the prefetch data for the program, and instructing the prefetching part to prefetch the data of the program when there is the prefetch data for the program, in order to execute the program.

8. The memory management apparatus according to claim 7, further comprising:
a forecasting part for forecasting a program to be next executed,
wherein the prefetching control part is configured to instruct the data creating part to create the prefetch data when there is not the prefetch data for the forecasted program, and instruct the prefetching part to prefetch the data of the forecasted program when there is the prefetch data for the forecasted program.

9. A memory management method implemented by a memory management apparatus including a data input/output part for requesting to read data in units of blocks in a first size from a first storage medium and storing the data read from the first storage medium into a second storage medium, the method comprising:
creating prefetch data obtained by converting a history of the request to read the data from the first storage medium into data of which read position and size are indicated in units of blocks in a second size, the request being issued by the data input/output part in response to a request from a program to be prefetched; and
requesting the data input/output part to prefetch the data of the program from the first storage medium to the second storage medium based on the prefetch data.

10. A control program for causing a computer to perform a process comprising:
creating prefetch data obtained by converting a history of a request to read data from a first storage medium into data of which read position and size are indicated in units of blocks in a second size, the request being issued by a data input/output part in response to a request from a program to be prefetched, the data input/output part requesting to read data in units of blocks in a first size from the first storage medium and storing the data read from the first storage medium into a second storage medium; and
requesting the data input/output part to prefetch the data of the program from the first storage medium to the second storage medium based on the prefetch data.

11. A computer readable recording medium in which the program according to claim 10 has been recorded.
